(19) United States
(12) Patent Application Publication
(10) Pub. No.: US 2007/0162427 A1
(43) Pub. Date: Jul. 12, 2007

(54) Query parameter output page finding method, query parameter output page finding apparatus, and computer product

(75) Inventor: Yuji Yamaoka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/412,957

(22) Filed: Apr. 28, 2006

(30) Foreign Application Priority Data
Jan. 6, 2006 (JP) 2006-001879

(51) Int. Cl. G06F 17/30

(52) U.S. Cl. 707/2

(57) ABSTRACT

An apparatus that finds an output page on which a query parameter value input by a user is output, includes an output page detector that detects an output page, designating not only the page immediately after the query parameter value input by the user, but also a page output by a target website as a detection target region.

### BACKGROUND OF THE INVENTION

1. Field of the Invention

The present invention relates to a technology for finding a page that outputs the query parameter input by a user.

2. Description of the Related Art

When cross site scripting (XSS) vulnerability is tested with respect to a Web application, query parameter input/output relationship analysis for detecting a page, on which a character string input to a query parameter is directly output, becomes important. The XSS means that a program for displaying a character string input by a user of a website directly on a screen sends a malicious script to user's browser. Damages due to XSS include cookie theft, which means that a browser executes a malicious script, thereby its cookie data is intercepted.

FIG. 10 is a schematic for explaining the query parameter input/output relationship analysis. The query parameter input/output relationship analysis is to find a page, on which a value “XXX” input as a query parameter is output.

After such a page is found, the XSS vulnerability can be tested by inserting a script based on the position of an input value on the output page, and testing whether the inserted script is executed on a client. Accordingly, it is important for the XSS vulnerability test to find a page that outputs the value input as the query parameter. A technique for finding such a page is described, for example, in Japanese Patent Application Laid-Open No. 2004-164617.

The conventional technique, however, has a problem that the page that outputs the query parameter value is searched, targeting only a page immediately after an input of a query parameter value. FIG. 11 is a schematic for explaining the problem in the conventional technique. In the conventional technique, a test is executed by inputting, for example, <foo> as a query parameter value, and checking whether there exists a page that outputs <foo>, designating only a response page immediately after the input as a target region.

Therefore, in the conventional technique, if there is a page, on which the query parameter value is output, other than the response page immediately after the input, such a page cannot be found. In addition, a transition change accompanying a change in the query parameter value cannot be detected.

Furthermore, when a value input as the query parameter is the generally used character string “XXX”, it cannot be determined whether the character string “XXX” output on the page is the query parameter value or a value output irrelevantly to the query parameter value.

### SUMMARY OF THE INVENTION

It is an object of the present invention to at least solve the problems in the conventional technology.

According to an aspect of the present invention, a method of finding an output page on which a query parameter value input by a user is output, includes detecting an output page, designating not only the page immediately after the query parameter value input by the user, but also a page output by a target website as a detection target region.

According to another aspect of the present invention, an apparatus that finds an output page on which a query parameter value input by a user is output, includes an output page detector that detects an output page, designating not only the page immediately after the query parameter value input by the user, but also a page output by a target website as a detection target region.

According to still another aspect of the present invention, a computer-readable recording medium stores therein a computer program that realizes the above method according to the present invention on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an explanatory diagram of the concept of a query parameter output page group finding apparatus according to an embodiment of the present invention;

FIG. 2 is a functional block diagram of the configuration of the query parameter output page group finding apparatus according to the embodiment;

FIG. 3 is an example of a page transition model configured by a page reproduction/reproduction result verifying unit;

FIG. 4 is an example of a principle setting GUI for setting a finding principle by a user;

FIG. 5 is one example of a tracer value specifying GUI;

FIG. 6 is one example of an analysis result output by a found result output unit;

FIG. 7 is a flowchart of a process procedure performed by an output page group detector;

FIG. 8 is an explanatory diagram of the relationship between effects of the query parameter output page group finding apparatus according to the embodiment and of a main processing flow;

FIG. 9 is a functional block diagram of the configuration of a computer executing a query parameter output page group finding program according to the embodiment;

FIG. 10 is an explanatory diagram of a query parameter input/output relationship analysis; and

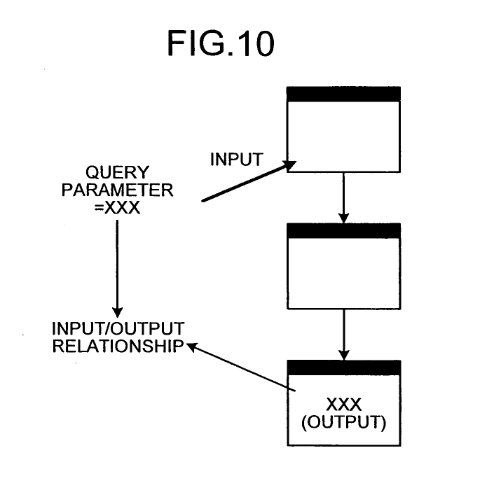

FIG. 11 is an explanatory diagram of a problem in a conventional technique.

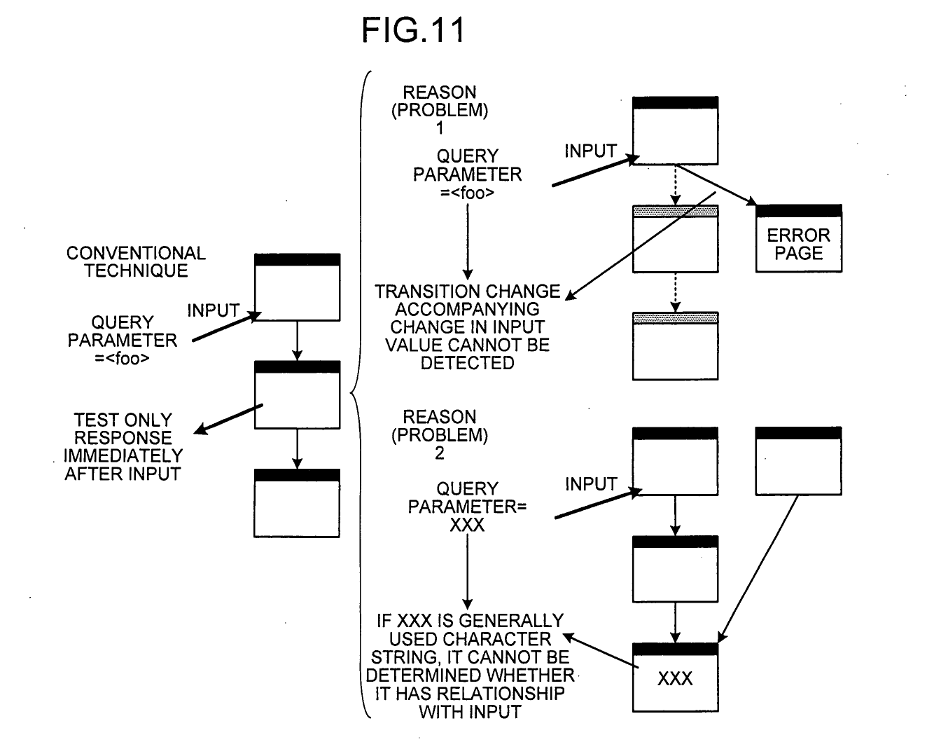

### DETAILED DESCRIPTION OF THE PREFERRED EMBODIMENTS

Exemplary embodiments of the present invention will be explained below in detail with reference to the accompanying drawings.

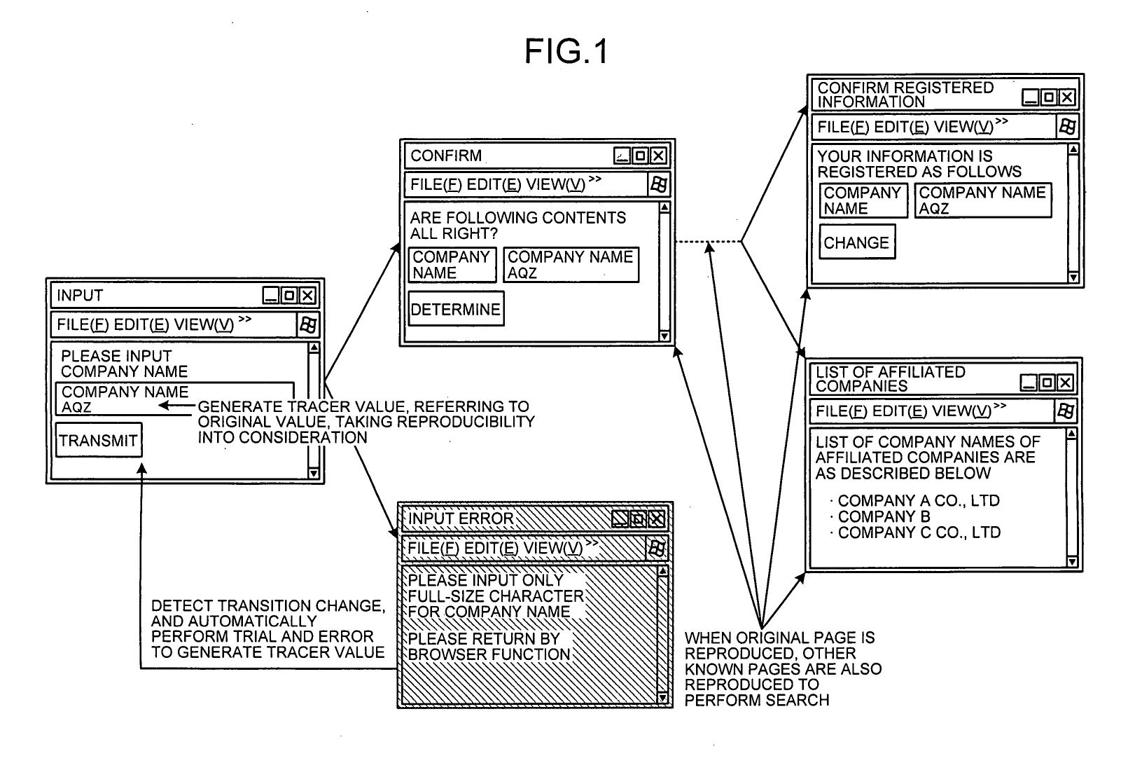

The concept of a query parameter output page group finding apparatus according to one embodiment is explained first. FIG. 1 is an explanatory diagram of the concept of the query parameter output page group finding apparatus according to this embodiment.

As shown in FIG. 1, the query parameter output page group finding apparatus according to this embodiment generates a tracer value traceable based on an original query parameter input value (a traceable character string), and tests whether the original page is reproduced, designating the generated tracer value as the query parameter.

The tracer value is a value hardly used in general, and easily traced as a value used for analyzing query parameter input and output relationship. For example, when it is assumed that “company A” is a query parameter input value, there is the high possibility that “company A” is used for other than the query parameter input value. Hence, the query parameter output page group finding apparatus according to the present embodiment adds “QZ” to “company A” to generate a tracer value “company AQZ”, and tests whether the same page as the page at the time of inputting “company A” is reproduced, when “company AQZ” is input.

When the same page as the page at the time of inputting “company A” is reproduced, a page that outputs a query parameter value is searched by using the tracer value, targeting not only the page immediately after the input, but also a region held as an already-known page by the query parameter output page group finding apparatus. On the other hand, when the same page as that at the time of inputting “company A”, such as a page that warns an input error, is not reproduced, another tracer value is generated to repeat trial and error until the page is reproduced.

In this manner, the query parameter output page group finding apparatus according to this embodiment can find a query parameter value output page, which cannot be found according to the conventional method, by searching a query parameter value output page by using the tracer value, targeting not only the page immediately after the input of the query parameter value, but also all pages held as the already-known page.

The query parameter output page group finding apparatus according to the present embodiment generates a tracer value based on the query parameter value, and uses the generated tracer value instead of the query parameter value, thereby preventing misdetection of a page, on which the same character string is used by chance irrelevantly to the query parameter value.

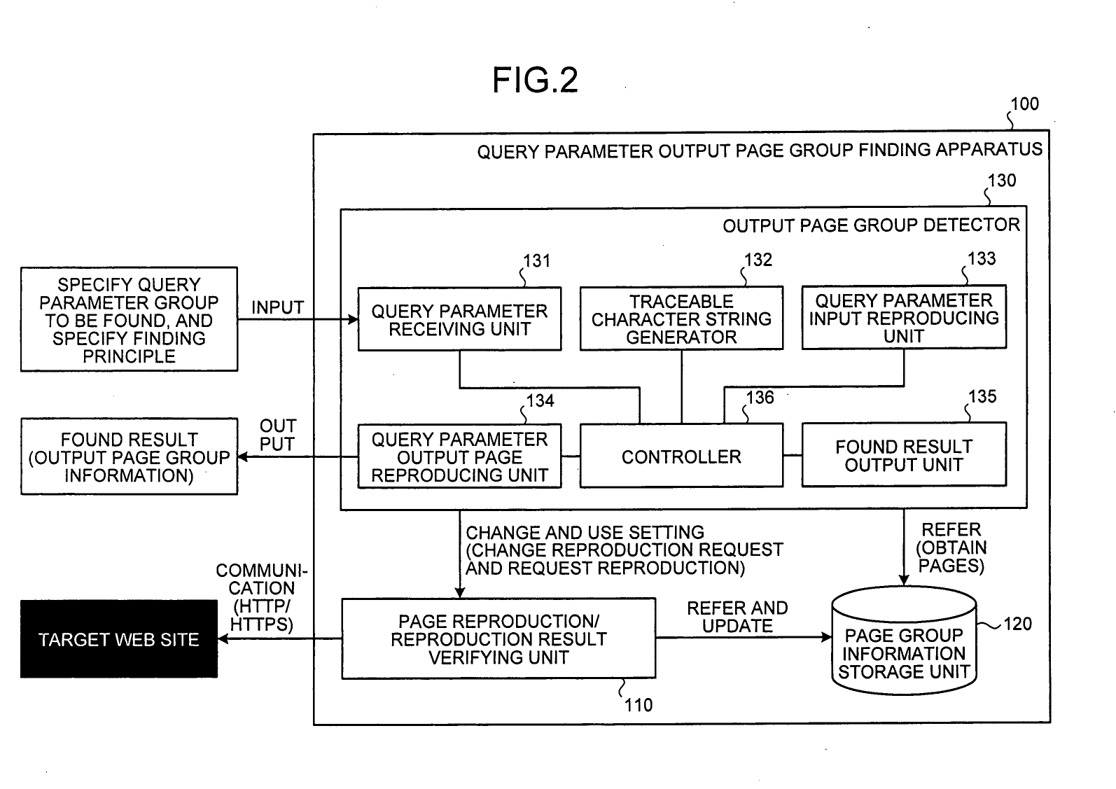

The configuration of the query parameter output page group finding apparatus according to this embodiment is explained next. FIG. 2 is a functional block diagram of the configuration of the query parameter output page group finding apparatus according to this embodiment.

As shown in FIG. 2, a query parameter output page group finding apparatus 100 includes a page reproduction/reproduction result verifying unit 110, a page group information storage unit 120, and an output page group detector 130.

The page reproduction/reproduction result verifying unit 110 reproduces a page output by a target website, and verifies whether the reproduced page matches an expected page. The page reproduction/reproduction result verifying unit 110 holds a record of reproduction trial methods and the verification method of the respective pages of the target website, to reproduce the page and verify the reproduction result.

The record of the reproduction trial methods is a list of generation methods of requests transmitted to the target website, and the record of the verification method is a list of response properties expected with respect to the list of the generation methods of requests transmitted to the target website. These records can be referred to or changed from outside.

Upon reception of an instruction to perform reproduction trial of an optional page, the page reproduction/reproduction result verifying unit 110 tries reproduction of the page according to the reproduction trial method, verifies whether the obtained response list is the expected one by the verification method, and notifies the result.

The page reproduction/reproduction result verifying unit 110 collects page information from the target website, classifies the collected pages into page classes, and builds a page transition model by modeling the transition of the pages. The page reproduction/reproduction result verifying unit 110 determines one reproduction request used at the time of performing reproduction trial of the respective page classes (classification unit of page group), and determines a prerequisite at the time of transmitting the request (which page class is to be subjected to reproduction trial immediately before the transmission).

When reproduction trial of a page classified in a certain page class is requested, the page reproduction/reproduction result verifying unit 110 sequentially performs reproduction trial of a page class group, which becomes the prerequisite, based on the page transition model, and lastly performs reproduction trial of a specified page class by transmitting a reproduction request. In that case, the page reproduction/reproduction result verifying unit 110 automatically verifies whether the pages obtained by respective requests are classified into the page classes expected at that time. When the obtained page is not classified into the expected page class, the page reproduction/reproduction result verifying unit 110 suspends the reproduction trial and notifies this matter.

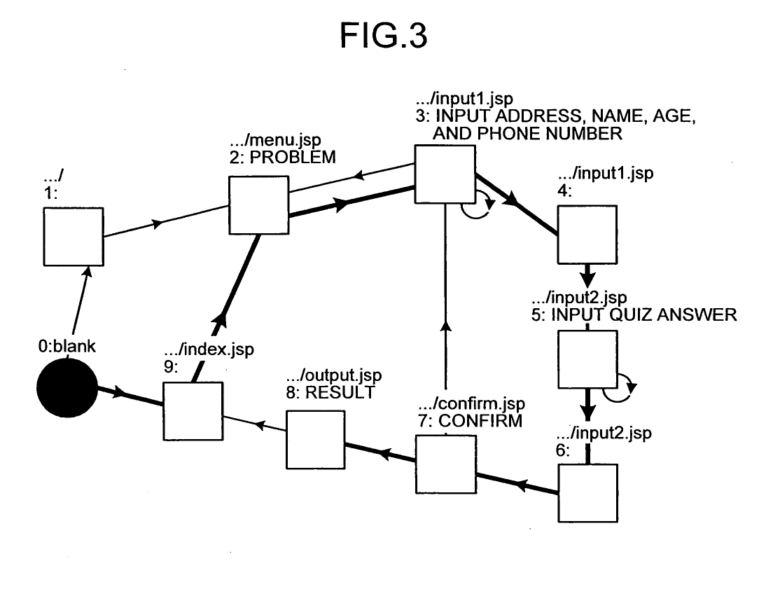

FIG. 3 is an example of the page transition model built by the page reproduction/reproduction result verifying unit 110. In FIG. 3, respective squares indicate a page class. A reproduction route of a page class written as “8: output” is shown by a thick line.

That is, when the reproduction trial of “8: output” is requested, the page reproduction/reproduction result verifying unit 110 requests “9:” based on a set reproduction request, and confirms that the page obtained by the request is certainly classified in “9:”, or when the page is not classified in “9:”, notifies this matter.

Subsequently, the page reproduction/reproduction result verifying unit 110 requests “2: menu” based on the set reproduction request, and confirms the obtained page is certainly classified in “2: menu”, or when the page is not classified in “2: menu”, notifies this matter. Hereinafter, the page reproduction/reproduction result verifying unit 110 reproduces likewise until “8: output”. The details of the page reproduction/reproduction result verifying unit 110 are described in, for example, Japanese Patent Application No. 2004-237551.

The page group information storage unit 120 stores information required for reproduction of pages such as the page transition model and verification of the reproduction result. The page reproduction/reproduction result verifying unit 110 collects information from the target website, constructs the page transition model and the like, and stores the model in the page group information storage unit 120.

The output page group detector 130 detects the query parameter output page by using the page reproduction/reproduction result verifying unit 110, and includes a query parameter receiving unit 131, a traceable character string generator 132, a query parameter input reproducing unit 133, a query parameter output page reproducing unit 134, a found result output unit 135, and a controller 136.

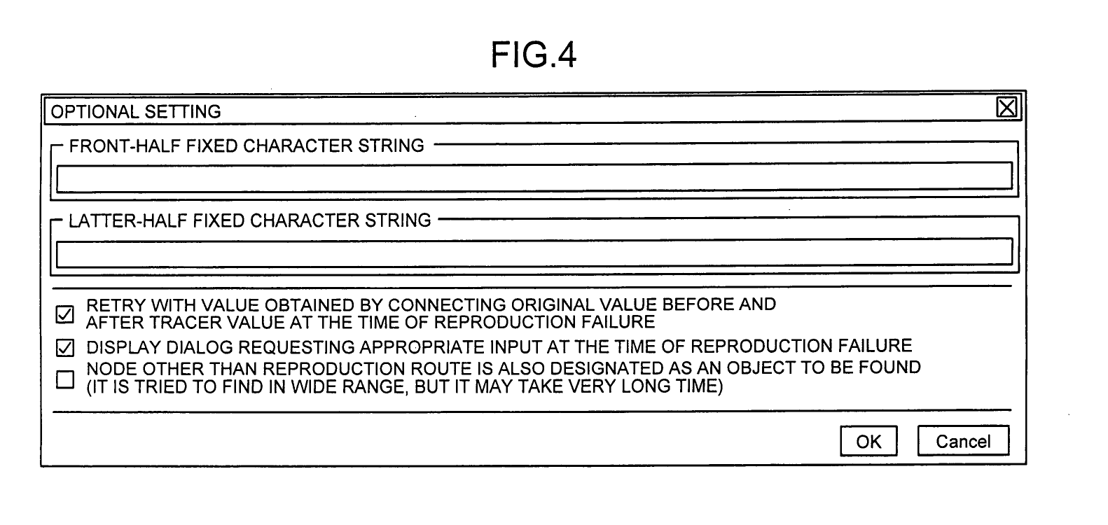

The query parameter receiving unit 131 receives a query parameter group, which is an object of the input/output relationship analysis, the value thereof, a finding principle, and the like from a user. FIG. 4 is an example of the principle setting GUI for setting the finding principle by the user.

As shown in FIG. 4, the user can specify first half fixed character string, second half fixed character string, measures at the time of reproduction failure, and a finding target region by using the principle setting GUI. The first half fixed character string and the second half fixed character string are used for generating the tracer value, and specification of the finding target region is for specifying whether only the page located in the reproduction route is designated as the finding target or all pages stored in the page group information storage unit 120 is designated as the finding target.

The traceable character string generator 132 generates the tracer value based on the query parameter value received by the query parameter receiving unit 131. Characteristics of the tracer value include “uniqueness” and “acceptance”. The “uniqueness” means that the tracer value is rarely used and when it is output from a Web application, the input of the tracer value is recognized. The “acceptance” means that the tracer value is accepted by the Web application in the same manner as an original query parameter value, that is, so that the same control as that when the original query parameter value is input by the Web application is performed.

The traceable character string generator 132 determines a character type forming the tracer value from the query parameter value after URL decoding, so as to satisfy the “acceptance”. Specifically, half-width lower case letters [0x61, 0x7A] are most likely to be accepted, and hence, the character type is determined in the following manner:

(1) When a half-width lower case letter is included in the query parameter value, the character type is determined as the half-width lower case letter.

(2) When a half-width upper case letter [0x41, 0x5A] is included in the query parameter value, the character type is determined as the half-width upper case letter.

(3) When a half-width numeric character [0x30, 0x39] is included in the query parameter value, the character type is determined as the half-width numeric character.

(4) When Japanese Hiragana script is included in the query parameter value, the character type is determined as hiragana.

(5) When a full-width Japanese Katakana script is included in the query parameter value, the character type is determined as full-width katakana.

(6) When half-width Japanese Katakana script is included in the query parameter value, the character type is determined as half-width Katakana.

(7) When other multibyte characters (characters that are not encoded to one byte in Unicode Transformation Format (UTF)-8, excluding non-letter symbols) are included in the query parameter value, the character type is determined as a character type of a language including the character (corresponding to Japanese Hiragana script).

(8) Otherwise, the character type is determined as half-width lower case letter.

The traceable character string generator 132 determines a character string peculiar to the language including the character (character row that is not used commonly), so as to satisfy the “uniqueness”. For example, the peculiar character string is determined in the following manner.

(1) In the case of half-width lower case letter; the character string is “qz”,

(2) In the case of half-width upper case letter, the character string is “QZ”,

(3) In the case of half-width numerical character, the character string is “7654”,

(4) In the case of the Hiragana script, the character string is “ [symbol] [symbol] ”,

(5) In the case of full-width Japanese Katakana script, the character string is “ [symbol] [symbol] ”, and

(5) In the case of half-width Japanese Katakana script, the character string is “ [symbol] [symbol] ” (half-width [symbol] )

The traceable character string generator 132 also determines to use an unused character string from the shortest character string space, in which the size of a figure becomes the total number of target query parameters, so as to satisfy the “uniqueness”. For example, when the total number of target query parameters is 676 and the character type is the half-width lower case letter, since the shortest character string in which the size of a figure becomes 676 is two characters (26 in the case of lower case letter, and hence, the size of the figure in the character string space including two characters is 26×26=676), an unused character string is used from the character string space including two character formed of “aa” to “zz”. When the number of query parameters is 677, the shortest character string space becomes a character string space including three characters, and hence, an unused character string is used from the character string space formed of “aaa” to “baa”. In the case of the half-width lower case letter, therefore, the character string becomes “qzaa” or the like.

The traceable character string generator 132 determines a tracer value obtained by connecting a “front-half fixed character string” and a “latter-half fixed character string” specified by a user on the GUI shown in FIG. 4 to the character string before and after thereof as a “default tracer value”. Such a connection of the predetermined character strings is useful when it is known beforehand that the target Web application can easily accept the tracer value when there is a specific character string in the front half or the latter half of the query parameter value.

Thus, since the traceable character string generator 132 generates a tracer value that has excellent “uniqueness” and “acceptance” based on the query parameter value accepted by the query parameter receiving unit 131, the query parameter value output page can be found accurately and efficiently.

Furthermore, the traceable character string generator 132 regenerates the tracer value based on an instruction from the query parameter input reproducing unit 133. Specifically, when it is assumed that an original value of the query parameter is an original value, the traceable character string generator 132 generates:

(1) original value+“default tracer value”;

(2) “default tracer value”+original value; and

(3) original value+“default tracer value”+original value. “+” means connection of character strings. The original value is connected when the tracer value is reproduced, because the Web application that has accepted the original value is likely to accept a character string in which the original value is added before and after the tracer value.

When the reproduced tracer value is not accepted, the traceable character string generator 132 requests the user to create a tracer value based on an instruction from the query parameter input reproducing unit 133.

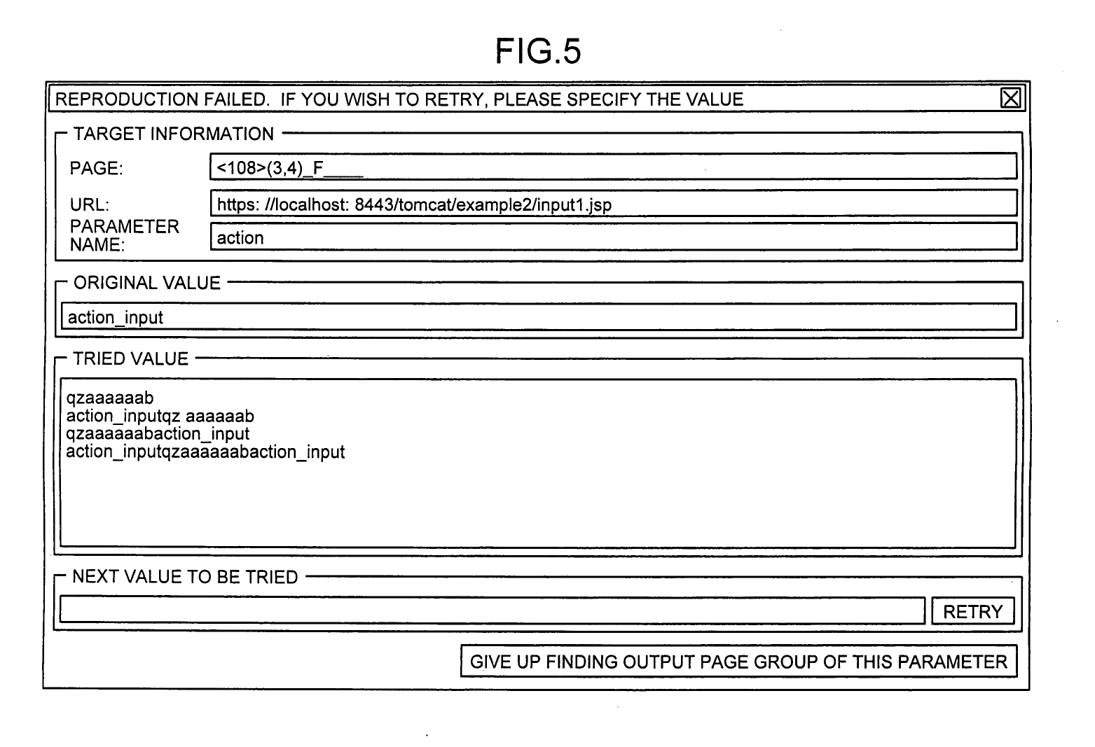

FIG. 5 is one example of a tracer value specifying GUI. As shown in FIG. 5, in this GUI, tried values are shown, and the user is requested to input another value to be tried. When the user inputs a tracer value and presses a “retry” button, the tracer value is sent to the query parameter input reproducing unit 133. On the other hand, when the user presses a “give up finding output page group of this parameter” button without inputting the tracer value, this matter is informed to the query parameter input reproducing unit 133.

The query parameter input reproducing unit 133 is a processor that reproduces an input of the query parameter by using the page reproduction/reproduction result verifying unit 110. That is, the query parameter input reproducing unit 133 generates a test request in which the query parameter value is changed to a tracer value from the original request generated by inputting the query parameter, and tries to reproduce a page classified in a page class in which the page obtained by the original request is classified, by using the page reproduction/reproduction result verifying unit 110. As a result, when the page classified in the same page class as the original request is reproduced, it is assumed that the tracer value is accepted by the target Web application.

For example, a test request http://example.com/?p1=qzaa&p2=CAPITAL, in which the value of “p1” is changed to “qzaa”, or the like is generated, when the target is “p1”, from http://example.com/?p1=small&p2=CAPITAL, and when the target is “p2”, http://example.com/?p1=small&p2=QZAB”, in which the value of “p2” is changed to “QZAB”, or the like is generated as the test request, respectively.

For example, when a query parameter “p” in a reproduction request http://example.com/?p=v in page class “4:” in FIG. 3 is a target, a test request in which the value of “p” is changed to “qzac” is generated. When the page class “4:” is to be reproduced, the query parameter input reproducing unit 133 instructs the page reproduction/reproduction result verifying unit 110 to perform reproduction trial of “3: input of address, name, age, and phone number”, and when the trial is a success (when the trial is a failure, a fatal error is output to suspend finding processing), the test request is transmitted. It is then verified whether the page obtained thereby is classified in the same page class “4:” as the original page.

Furthermore, when the query parameter input reproducing unit 133 tries to reproduce the page classified in the page class, in which the page obtained by the original request is classified, and as a result, when the page classified in the same page class as the original request is not reproduced, that is, the obtained page is not classified in a presumed page class, it is assumed that the tracer value is not accepted by the Web application. This is because the Web application often outputs the result whether to accept the input parameter value immediately after the input.

When retrial is set, that is, it is set to “retry with a value obtained by connecting the original value before and after the tracer value at the time of reproduction failure” on the principle setting GUI shown in FIG. 4, the query parameter input reproducing unit 133 instructs the traceable character string generator 132 to regenerate a tracer value, and retries reproduction by using the regenerated tracer value.

When manual setting of a tracer value is specified when the tracer value regenerated by the traceable character string generator 132 is not accepted, that is, it is set to “display a dialog requesting appropriate input at the time of reproduction failure” on the principle setting GUI shown in FIG. 4, the query parameter input reproducing unit 133 instructs the traceable character string generator 132 to ask the user to specify a tracer value.

When the user specifies the tracer value, the query parameter input reproducing unit 133 retries reproduction by using the specified tracer value. On the other hand, when the user gives up finding the output page relating to the query parameter, the query parameter input reproducing unit 133 suspends reproduction.

The query parameter output page reproducing unit 134 detects a page that outputs the query parameter value, by using the page reproduction/reproduction result verifying unit 110. That is, when reproduction of the query parameter input by the query parameter input reproducing unit 133 is a success, the query parameter output page reproducing unit 134 uses the successful test request as a reproduction request to reproduce all the page classes, which are candidates to be found, by using the page reproduction/reproduction result verifying unit 110, monitors the output of the tracer value set in the test request, and detects a page that outputs the query parameter value.

For example, it is assumed that a test request http://example.com/?p=qzac, in which the value of “p” is changed to “qzac”, with respect to the query parameter “p” in http://example.com/?p=v, which is a reproduction request of page class “4:” shown in FIG. 3, reproduces “4:”.

The query parameter then output page reproducing unit 134 searches a page including “v”, which is the original value of “p”, from the whole page information stored in the page group information storage unit 120, to narrow down to which page classes the query parameter value can be output, and designates the page classes as a candidate page class group.

For example, it is assumed that “1:”, “7: confirm”, and “8: output” are the candidate page class group in FIG. 3 (that is, “v” is output on the page classified in these three page classes). At this time, the query parameter output page reproducing unit 134 instructs the page reproduction/reproduction result verifying unit 110 to perform reproduction trial of “1:” and “8: output”. “7: confirm” is on a reproduction route of “8: output”, and when “8: output” is reproduced, “7: confirm” is also reproduced. Therefore, reproduction trial of “7: confirm” is not instructed to the page reproduction/reproduction result verifying unit 110.

At the time of reproduction trial, when “4:” is passed, a request to be used at the time of performing reproduction trial of “4:” is replaced by the test request. The query parameter output page reproducing unit 134 monitors whether the tracer value “qzac” is output in “1:”, “7: confirm”, and “8: output” during reproduction, and when the tracer value is output, the page class is output as a found page.

In performing reproduction trial, when reproduction is a failure, it is difficult to guess the cause. Therefore, it is only output that reproduction is a failure. Furthermore, in a page class “1:”, which does not pass through “4:”, when “node other than reproduction route (node is a page class) is also designated as an object to be found” is not set on the principle setting GUI shown in FIG. 4, for efficiency improvement, this is excluded from the objects to be tested. This is because the query parameter value is likely to be output in a page in which the query parameter is input and traced (in this example, a page passing through “4:”), than a page in which a certain course is taken without inputting the query parameter (in this example, a page not passing through “4:”).

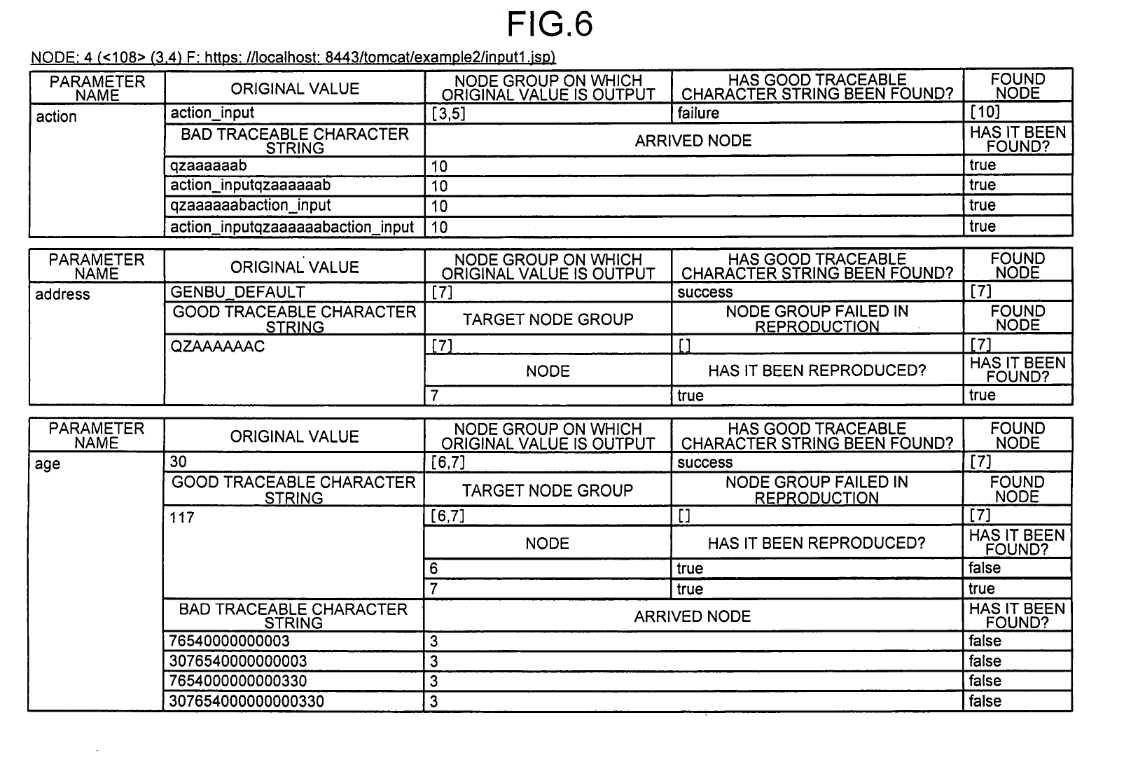

The found result output unit 135 is a processor that outputs an analysis result such as the query parameter value output page detected by the query parameter output page reproducing unit 134 and the like. FIG. 6 is one example of an analysis result output by the found result output unit 135.

Analysis results for three query parameters, “action”, “address”, and “age”, which are included in a page shifted from node (page class) “3” to “4”, are shown in FIG. 6.

For example, regarding “age”, the following information is output.

The original value is “30”, and the page class group, in which “30” is output, is node “6” and “7”, of all pages.

Thereafter, test requests by using “76540000000003” and other three values as a tracer value (traceable character string) were tried, but these did not shift to the original node “4”, but shifted to “3”. The traceable character string was not found in the shifted page.

Thereafter, a test request by using “117” as the traceable character string was tried, and as a result, the original node “4” was reproduced, and reproduction of nodes “6, 7” was tried. As a result, “6” was reproduced, however, the traceable character string “117” was not found therein. “7” was also reproduced, and the traceable character string “117” was found therein.

As shown in FIG. 3, the page classified in the found node “7” is not a page immediately after the node “3”, and it is seen that a page that could not have been found by conventional techniques, in which only a page immediately afterwards is designated as a target region to be found, can be found.

The controller 136 is a processor that controls the entire query parameter output page group finding apparatus 100, and specifically, makes the query parameter output page group finding apparatus 100 function as one apparatus, by shifting the control between functional units and transferring data between the functional units and the storage unit.

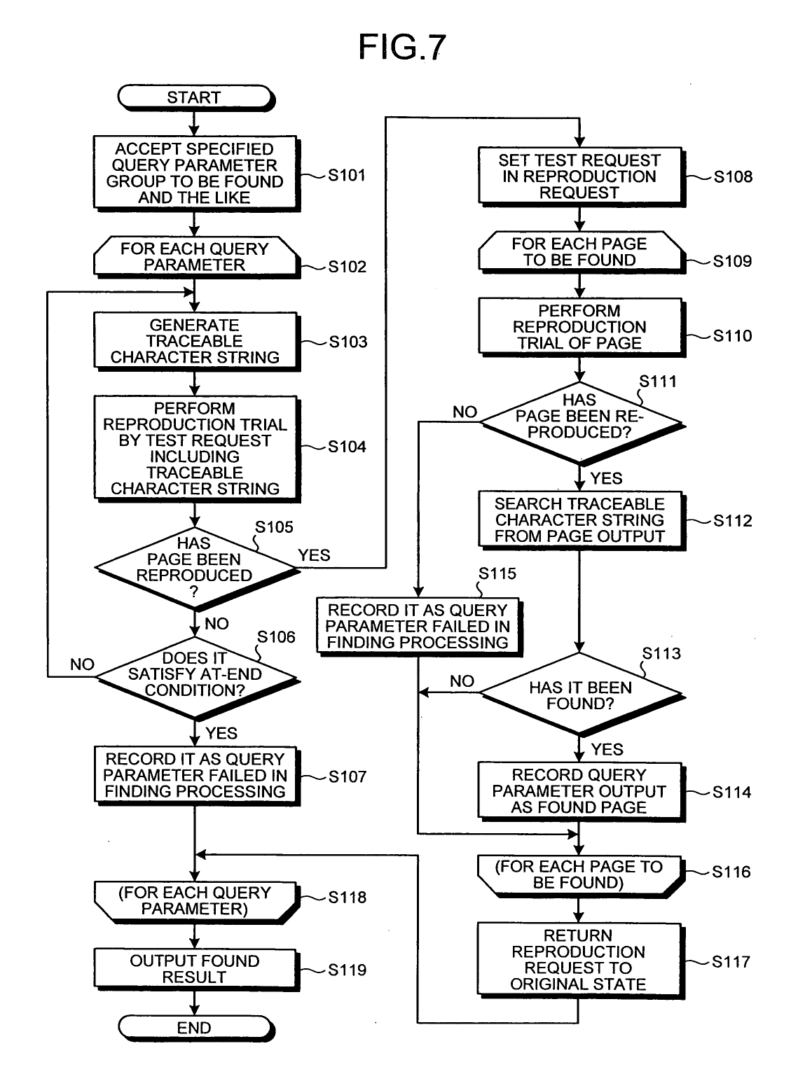

A process procedure performed by the output page group detector 130 is explained next. FIG. 7 is a flowchart of the process procedure performed by the output page group detector 130. As shown in FIG. 7, in the output page group detector 130, the query parameter receiving unit 131 first accepts a specified query parameter group to be found and a specified principle (step S101), and the controller 136 controls so that processing from step S102 to step S118 is repeated for each query parameter.

As the repeated processing, the traceable character string generator 132 generates a traceable character string (tracer value) based on the query parameter value (step S103), and the query parameter input reproducing unit 133 instructs the page reproduction/reproduction result verifying unit 110 to perform reproduction trial of the original page by a test request including the traceable character string (step S104).

The query parameter input reproducing unit 133 then determines whether the original page has been reproduced (step S105). As a result, when the original page has not been reproduced, the controller 136 determines whether an at-end condition is satisfied (step S106). When the at-end condition is not satisfied, control returns to step S103, to regenerate a traceable character string. When the at-end condition is satisfied, the query parameter input reproducing unit 133 records the query parameter as a query parameter failed in the finding processing (step S107), and performs processing with respect to a next query parameter. The at-end condition is a condition determined based on a finding principle set by the user on the finding principle setting GUI shown in FIG. 4, and includes whether to perform retrial and the like.

On the other hand, when the original page has been reproduced, the controller 136 sets a test request in the reproduction request (step S108), and repeats processing from step S109 to step S116 for each candidate page, on which the original query parameter value is output.

As the repeated processing, the query parameter output page reproducing unit 134 instructs the page reproduction/reproduction result verifying unit 110 to perform reproduction trial of the page by using the traceable character string (step S110), to determine whether the page has been reproduced (step S111).

As a result, when the page has been reproduced, the query parameter output page reproducing unit 134 searches the traceable character string from the page output (step S112), to determine whether the traceable character string has been found (step S113). When the traceable character string has been found, the query parameter output page reproducing unit 134 records the output of the query parameter as a found page (step S114).

On the other hand, when the page has not been found, the query parameter output page reproducing unit 134 records the page as a page failed in the finding processing (step S115).

When the repeated processing from step S109 to step S116 has finished for all candidate pages, the controller 136 returns the reproduction request to the original state, to perform processing with respect to the next query parameter.

Lastly, the found result output unit 135 outputs the found result (analysis result) to finish the processing (step S119).

Thus, the output page group detector 130 generates the traceable character string, and monitors the output of the traceable character string, while reproducing the page by using the page reproduction/reproduction result verifying unit 110, thereby finding the output page of the query parameter.

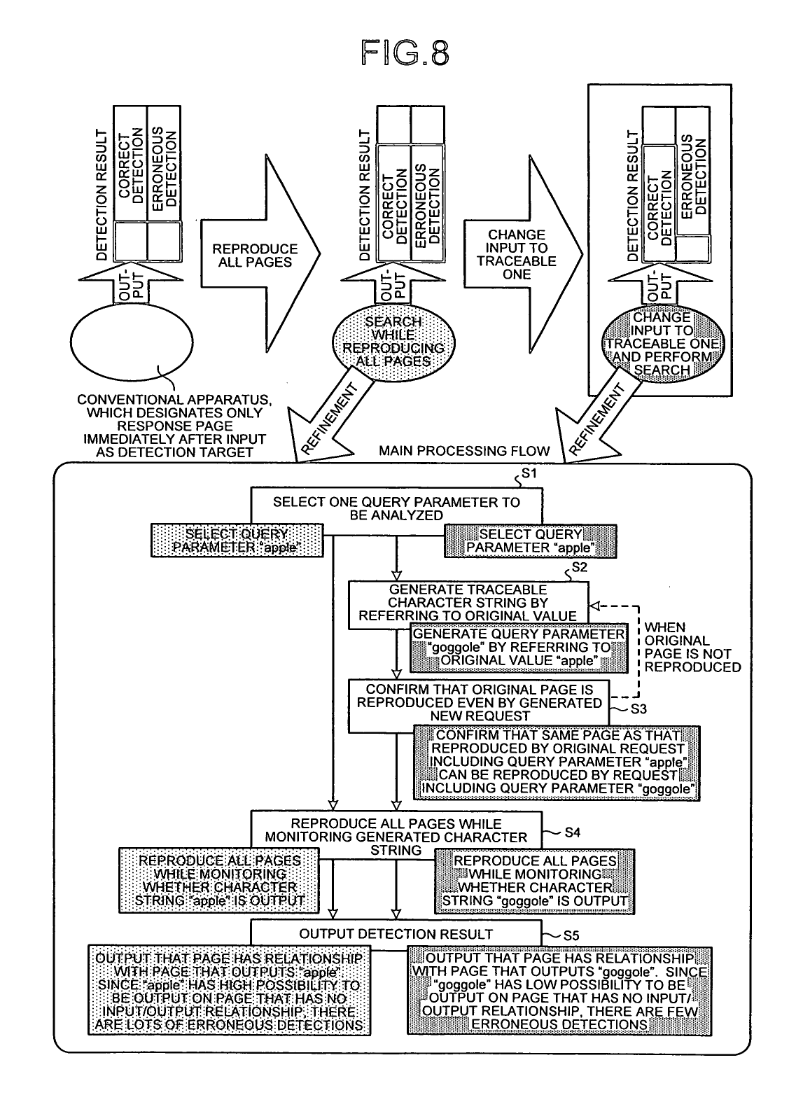

The relationship between the effects of the query parameter output page group finding apparatus 100 according to this embodiment and the main processing flow is explained next. FIG. 8 is an explanatory diagram of the relationship between the effects of the query parameter output page group finding apparatus 100 according to this embodiment, and of the main processing flow.

As shown in FIG. 8, conventionally, only the response page immediately after the input of the query parameter value is designated as the detection target, and hence, the detection result has been limited to a narrow range. Therefore, the query parameter output page group finding apparatus 100 according to this embodiment enlarges the detection range, by selecting a query parameter (step S1), reproducing all pages for the selected query parameter (step S4), and outputting a detection result indicating whether the page is an output page of the query parameter value (step S5).

For example, the query parameter output page group finding apparatus 100 selects “apple” as a query parameter (step S1), monitors the output of a character string “apple” while reproducing all pages (step S4), and outputs a page, on which “apple” is output, as a found page (step S5). As a result, the detection range can be enlarged.

Furthermore, the query parameter output page group finding apparatus 100 according to this embodiment selects a query parameter (step S1), generates a traceable character string by referring to an original value of the selected query parameter (step S2), confirms that the original page is reproduced by a new request using the generated traceable character string (step S3), reproduces all pages while monitoring the generated traceable character string (step S4), and outputs a detection result of the output page of the traceable character string (step S5). Accordingly, the query parameter output page group finding apparatus 100 can reduce erroneous detection.

For example, when the query parameter output page group finding apparatus 100 selects “apple” as a query parameter (step S1), generates “goggole” by referring to “apple” (step S2) confirms that the original page is reproduced by “goggole” (step S3), and when the original page is reproduced, monitors the output of a character string “goggole” while reproducing all pages (step S4), and outputs a page on which “goggole” is output as a found page (step S5). As a result, there is low possibility that “goggole” is output on an irrelevant page, and hence, erroneous detection can be reduced.

As described above, in this embodiment, the traceable character string generator 132 generates a tracer value based on the original query parameter value. The query parameter input reproducing unit 133 reproduces an input of a query parameter by using the tracer value, and when the query parameter input is reproduced, the query parameter output page reproducing unit 134 detects a page that outputs the query parameter value with respect to all pages stored in the page group information storage unit 120 by using the tracer value. Accordingly, the output page, on which the query parameter value input by the user is output, can be found highly accurately.

The query parameter input reproducing unit 133 and the query parameter output page reproducing unit 134 reproduce pages by using the page reproduction/reproduction result verifying unit 110, to verify the reproduction results.

In this embodiment, an example where pages are reproduced by using the page reproduction/reproduction result verifying unit 110 has been explained. However, the present invention is not limited thereto, and is also applicable to a case that reproduction trial of a page is performed while actually communicating with a target website.

In this embodiment, the query parameter output page group finding apparatus has been explained. However, by realizing the configuration of the query parameter output page group finding apparatus by software, a query parameter output page group finding program having the same function can be obtained. Therefore, a computer that executes the query parameter output page group finding program is explained.

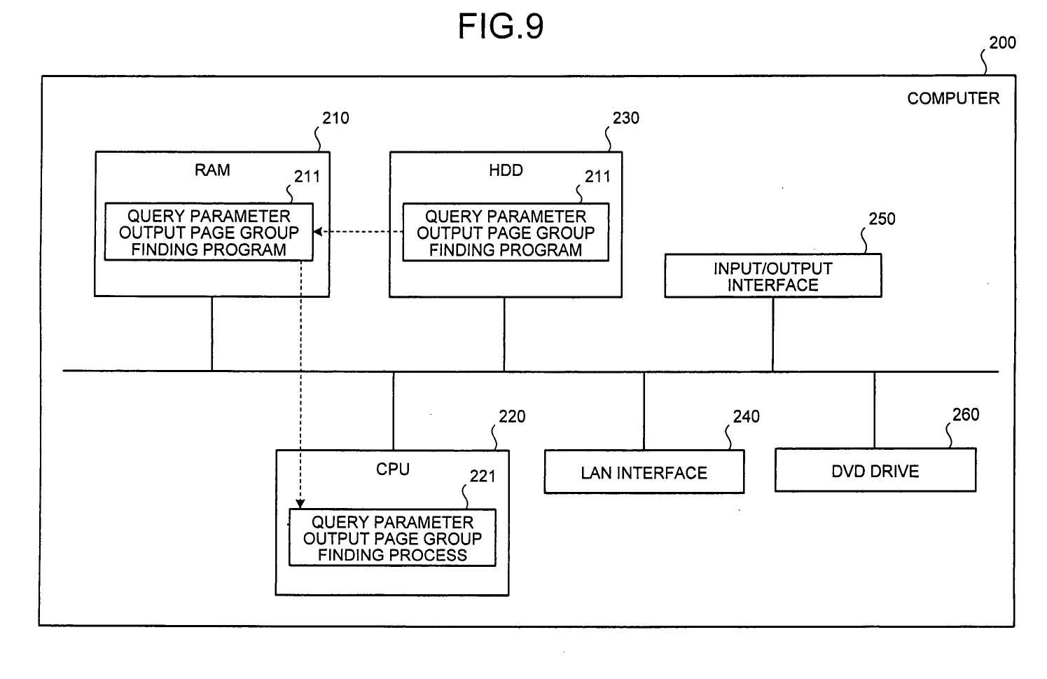

FIG. 9 is a functional block diagram of the configuration of a computer that executes the query parameter output page group finding program according to this embodiment. As shown in FIG. 9, this computer 200 includes a random access memory (RAM) 210, a central processing unit (CPU) 220, a hard disk drive (HDD) 230, a local area network (LAN) interface 240, an input/output interface 250, and a digital versatile disk (DVD) drive 260.

The RAM 210 is a memory that stores programs and execution interim results of the programs, and the CPU 220 reads out programs from the RAM 210 and executes the programs.

The HDD 230 is a disk device that stores programs and data, and the LAN interface 240 connects the computer 200 to other computers via the LAN.

The input/output interface 250 connects input units such as a mouse and a keyboard and a display unit, and the DVD drive 260 reads data from and writes data in a DVD.

A query parameter output page group finding program 211 executed by the computer 200 is stored in the DVD, read out from the DVD by the DVD drive 260 and installed in the computer 200.

Alternatively, the query parameter output page group finding program 211 is stored in a database of another computer system connected to the computer 200 via the LAN interface 240, read from the DVD and installed in the computer 200.

The installed query parameter output page group finding program 211 is stored in the HDD 230, read by the RAM 210, and executed by the CPU 220 as a query parameter output page group finding process 221.

According to an embodiment, since more output pages can be detected, detectability of the output page can be improved.

Moreover, since erroneous detection of the output page can be prevented, the output page can be found highly accurately.

Furthermore, since the output page can be detected accurately, the output page can be found highly accurately.

Moreover, since the possibility of finding the output page can be improved, the output page can be found highly accurately.

Furthermore, since the tracer value is changed to the one easily accepted by the target website, the possibility of reproducing the page can be improved.

Moreover, since the user specifies the tracer value, the user himself can improve the possibility of reproducing the page.

Furthermore, since the user is involved in generation of the tracer value, the user himself can improve the possibility of reproducing the page.

Moreover, since the detection range of the output page is limited, the output page can be found efficiently.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A computer-readable recording medium that records therein a computer program that causes a computer to implement finding an output page on which a query parameter value input by a user is output, the computer program causing the computer to execute:
detecting an output page, designating not only the page immediately after the query parameter value input by the user, but also a page output by a target website as a detection target region.

2. The computer-readable recording medium according to claim 1, the computer program further causing the computer to execute generating a tracer value, which has more excellent traceability than the query parameter value, from the query parameter value, wherein
the detecting includes detecting the output page by using the tracer value generated by the tracer value generator.

3. The computer-readable recording medium according to claim 2, the computer program further causing the computer to execute reproducing a page output by the target website and verify whether the reproduced page is an expected page, wherein
the detecting includes detecting the output page, while reproducing the page and verifying the reproduction result by the page reproduction result verifying unit, using the tracer value.

4. The computer-readable recording medium according to claim 3, the computer program further causing the computer to execute changing the tracer value when the page reproduced by the page reproduction result verifying unit is not the expected page, wherein
the detecting includes detecting the output page, while repeating reproduction of a page and verification of the reproduction result by the page reproduction result verifying unit by using the tracer value changed by the tracer value changing unit.

5. The computer-readable recording medium according to claim 4, wherein the changing includes changing the tracer value by connecting the query parameter value before and after the tracer value.

6. The computer-readable recording medium according to claim 4, wherein the changing includes changing a tracer value by accepting the tracer value from a user.

7. The computer-readable recording medium according to claim 2, wherein the generating includes generating a tracer value by connecting a character string specified by a user before and after a character string that has uniqueness.

8. The computer-readable recording medium according to claim 3, wherein the detecting includes detecting an output page by designating only a page included in a page reproduction route used for reproducing the page in the page reproduction result verifying procedure as a detection target region.

9. The computer-readable recording medium according to claim 7, wherein the detecting includes detecting an output page by designating only a page included in a page reproduction route used for reproducing the page in the page reproduction result verifying procedure as a detection target region.

10. A method of finding an output page on which a query parameter value input by a user is output, the method comprising:
detecting an output page, designating not only the page immediately after the query parameter value input by the user, but also a page output by a target website as a detection target region.

11. The method according to claim 10, further comprising generating a tracer value, which has more excellent traceability than the query parameter value, from the query parameter value, wherein
the detecting includes detecting the output page by using the tracer value generated by the tracer value generator.

12. The method according to claim 11, further comprising reproducing a page output by the target website and verify whether the reproduced page is an expected page, wherein
the detecting includes detecting the output page, while reproducing the page and verifying the reproduction result by the page reproduction result verifying unit, using the tracer value.

13. The method according to claim 12, further comprising changing the tracer value when the page reproduced by the page reproduction result verifying unit is not the expected page, wherein
the detecting includes detecting the output page, while repeating reproduction of a page and verification of the reproduction result by the page reproduction result verifying unit by using the tracer value changed by the tracer value changing unit.

14. An apparatus that finds an output page on which a query parameter value input by a user is output, the apparatus comprising:
an output page detector that detects an output page, designating not only the page immediately after the query parameter value input by the user, but also a page output by a target website as a detection target region.

15. The apparatus according to claim 14, further comprising a tracer value generator that generates a tracer value, which has more excellent traceability than the query parameter value, from the query parameter value, wherein
the output page detector detects the output page by using the tracer value generated by the tracer value generator.

16. The apparatus according to claim 15, further comprising a page reproduction result verifying unit that reproduces a page output by the target website and verifies whether the reproduced page is an expected page, wherein
the output page detector detects the output page, while reproducing the page and verifying the reproduction result by the page reproduction result verifying unit, using the tracer value.

17. The apparatus according to claim 16, further comprising a tracer value changing unit that changes the tracer value when the page reproduced by the page reproduction result verifying unit is not the expected page, wherein
the output page detector detects the output page, while repeating reproduction of a page and verification of the reproduction result by the page reproduction result verifying unit by using the tracer value changed by the tracer value changing unit.
